(19) United States
(12) Patent Application Publication
(10) Pub. No.: US 2025/0060166 A1
(43) Pub. Date: Feb. 20, 2025

(54) COOLING SYSTEM FOR DECREASING THE TEMPERATURE OF A SOLUTION

(71) Applicant: J.C. UNI-Tec, Inc., Gardena, CA (US)

(72) Inventor: Tom Hiroshi HASEGAWA, Gardena, CA (US)

(21) Appl. No.: 18/450,127

(22) Filed: Aug. 15, 2023

(51) Int. Cl. F28D 1/02; A23L 3/00; A23L 3/36; F28F 13/12

(52) U.S. Cl. CPC F28D 1/0213; A23L 3/001; A23L 3/361; F28F 13/125

(57) ABSTRACT

A cooling system is provided. The cooling system comprises a first solution tank configured for receiving a cooling fluid. The cooling system may also include a second solution tank within the first solution tank and configured for receiving a food edible solution. The cooling system may also include a cooling fluid tube coiled around the second solution tank. The cooling system may further include a food edible solution tube coiled around the cooling fluid tube and/or the second solution tank.

### TECHNICAL BACKGROUND

Various embodiments relate to a cooling system. For example, an example embodiment relates to a cooling system for cooling a cooling fluid food edible solution.

### BACKGROUND

After a liquid is heated, the liquid needs to cool before the liquid can be packaged, processed, or consumed if the liquid is a soup. While the soup is cooling, bacteria or other microbes may get into the soup and spoil it. Through applied effort, ingenuity, and innovation many deficiencies of conventional soup cooling systems have been solved by developing solutions that are structured in accordance with the embodiments of the present invention, many examples of which are described in detail herein.

### BRIEF SUMMARY

Various embodiments the present disclosure relate to a cooling system. In various embodiments, the cooling system is configured for cooling a food or edible solution. In various embodiments, the cooling system may comprise a first solution tank configured for receiving a cooling fluid. The cooling system may further comprise a second solution tank configured for receiving a food edible solution. In an example embodiment, the second solution tank may be disposed within the first solution tank. The cooling fluid may further comprise a cooling fluid tube coiled around the second solution tank. In an example embodiment, the cooling fluid tube may be coiled along a height direction of the second solution tank. The cooling system may further comprise a food edible solution tube coiled around the cooling fluid tube and/or the second solution tank and ending with a tank inlet. In an example embodiment, the food edible solution tube may be configured for receiving the food edible solution and may be configured for transporting the food edible solution to an inner portion of the second solution tank via the tank inlet.

In an example embodiment, the food edible solution tube may further comprise a receiving inlet configured to receive the food edible solution from outside the first solution tank.

In an example embodiment, the tank inlet may be configured to be at an angle, such that, the food edible solution exits the tank inlet at the same angle of the tank inlet.

In an example embodiment, the food edible solution may be configured to create a vortex configuration causing the food edible solution to combine within the second solution tank.

In an example embodiment, the cooling fluid tube, the food edible solution tube, and/or the second solution tank may be submerged at least partially in the cooling fluid.

In an example embodiment, the cooling fluid may be configured to be contained within a gap defined by a distance between the first solution tank and the second solution tank.

In an example embodiment, the cooling system may further comprise a compressor configured to pump the cooling fluid through the cooling fluid tube.

In an example embodiment, the cooling system may further comprise a capping assembly configured to secure to the first solution tank and enclose the first solution tank and the second solution tank.

In an example embodiment, the capping assembly may further comprise a vent assembly.

In an example embodiment, the vent assembly may be configured to translate from a closed configuration to an open configuration.

In an example embodiment, the vent assembly in the open configuration may be configured to let air escape from the second solution tank to an outside environment.

In an example embodiment, the vent assembly in the open configuration may be further configured to allow the food edible solution to flow through the food edible solution tube from a receiving inlet to the tank inlet.

In an example embodiment, the vent assembly may be switch to the closed configuration once a predetermined amount of the food edible solution exits the tank inlet to the second solution tank.

In an example embodiment, the vent assembly in the closed configuration may be configured to seal the first solution tank and/or the second solution tank from the outside environment preventing bacteria from entering the first solution tank and/or the second solution tank.

In an example embodiment, the temperature of the food edible solution may be configured to decrease while flowing through a receiving inlet to the tank inlet of the food edible solution tube.

In an example embodiment, the rate of decreasing temperature of the food edible solution may be configured to inhibit microbial and/or bacteria growth in the food edible solution.

In an example embodiment, the cooling system may further comprise a food edible solution outlet configured to release the food edible solution from the second solution tank.

In an example embodiment, the food edible solution may be configured to release from the food edible solution outlet due to a gravitational force.

In an example embodiment, the cooling fluid tube may be configured to be attached to the second solution tank.

In an example embodiment, the cooling system may further comprise a cooling fluid tube support frame.

The above summary is provided merely for the purpose of summarizing some example embodiments to provide a basic understanding of some aspects of the present disclosure. Accordingly, it will be appreciated that the above-described embodiments are merely examples and should not be construed to narrow the scope or spirit of the present disclosure in any way. It will be appreciated that the scope of the present disclosure encompasses many potential embodiments in addition to those here summarized, some of which will be further described below. Other features, aspects, and advantages of the subject will become apparent from the description, the drawings, and the claims.

### BRIEF DESCRIPTION OF THE DRAWINGS

Having thus described the invention in general terms, reference will now be made to the accompanying drawings, which are not necessarily drawn to scale, and wherein:

FIG. 1 illustrates a side view of an example cooling system in accordance with various embodiments of the present disclosure;

FIG. 2 illustrates a top view of an example cooling system with a capping assembly in an open configuration in accordance with various embodiments of the present disclosure;

FIG. 3A illustrates a side view of an example cooling fluid tube in accordance with various embodiments of the present disclosure;

FIG. 3B illustrates a cross-sectional view of a cooling system in accordance with various embodiments of the present disclosure;

FIG. 3C illustrates a top view of an example cooling system with a capping assembly in an open configuration in accordance with various embodiments of the present disclosure;

FIG. 4A illustrates a side view of an example cooling fluid tube in accordance with various embodiments of the present disclosure;

FIG. 4B illustrates a cross-sectional view of a cooling system in accordance with various embodiments of the present disclosure;

FIG. 4C illustrates a top view of an example cooling system with a capping assembly in an open configuration in accordance with various embodiments of the present disclosure;

FIG. 5A illustrates a cross-sectional view of a capping assembly with a vent assembly in a closed configuration in accordance with various embodiments of the present disclosure;

FIG. 5B illustrates a cross-sectional view of a vent assembly in an open configuration in accordance with various embodiments of the present disclosure;

FIG. 6A illustrates a cross-sectional view of a cooling system in accordance with various embodiments of the present disclosure; and

FIG. 6B illustrates a cross-sectional view of a cooling system in accordance with various embodiments of the present disclosure.

### DETAILED DESCRIPTION

Various embodiments now will be described more fully hereinafter with reference to the accompanying drawings, in which some, but not all embodiments are shown. Indeed, these embodiments may be embodied in many different forms and should not be construed as limited to the embodiments set forth herein; rather, these embodiments are provided so that this disclosure will satisfy applicable legal requirements. Like numbers refer to like elements throughout.

As used herein, the phrases “in one embodiment,” “according to one embodiment,” “in some embodiments,” and the like generally refer to the fact that the particular feature, structure, or characteristic following the phrase may be included in at least one embodiment of the present disclosure. Thus, the particular feature, structure, or characteristic may be included in more than one embodiment of the present disclosure such that these phrases do not necessarily refer to the same embodiment. As used herein, the terms “example,” “exemplary,” and the like are used to “serving as an example, instance, or illustration.” Any implementation, aspect, or design described herein as “example” or “exemplary” is not necessarily to be construed as preferred or advantageous over other implementations, aspects, or designs. Rather, use of the terms “example,” “exemplary,” and the like are intended to present concepts in a concrete fashion.

The figures are provided to illustrate some examples of the invention described. The figures are not to limit the scope of the present embodiment of the invention or the appended claims. Aspects of the example embodiment are described below with reference to example applications for illustration. It should be understood that specific details, relationships, and methods are set forth to provide a full understanding of the example embodiment. One of ordinary skill in the art recognize the example embodiment can be practice without one or more specific details and/or with other methods.

If the specification states a component or feature “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such components or features can be optionally included in some embodiments or can be excluded.

As used herein, terms such as “front,” “rear,” “top,” etc. are used for explanatory purposes in the examples provided below to describe the relative positions of certain components or portions of components. As used herein, the term “or” is used in both the alternative and conjunctive sense, unless otherwise indicated. The term “along,” and similarly utilized terms, means near or on, but not necessarily requiring directly on an edge or other referenced location. The terms “approximately,” “generally,” and “substantially” refer to within manufacturing and/or engineering design tolerances for the corresponding materials and/or elements unless otherwise indicated. The use of such terms is inclusive of and is intended to allow independent claiming of specific values listed. Thus, use of any such aforementioned terms, or similarly interchangeable terms, should not be taken to limit the spirit and scope of embodiments of the present invention. As used in the specification and the appended claims, the singular form of “a,” “an,” and “the” include plural references unless otherwise stated. The terms “includes” and/or “including,” when used in the specification, specify the presence of stated feature, elements, and/or components; it does not preclude the presence or addition of one or more other features, steps, operations, elements, components, and/or groups thereof.

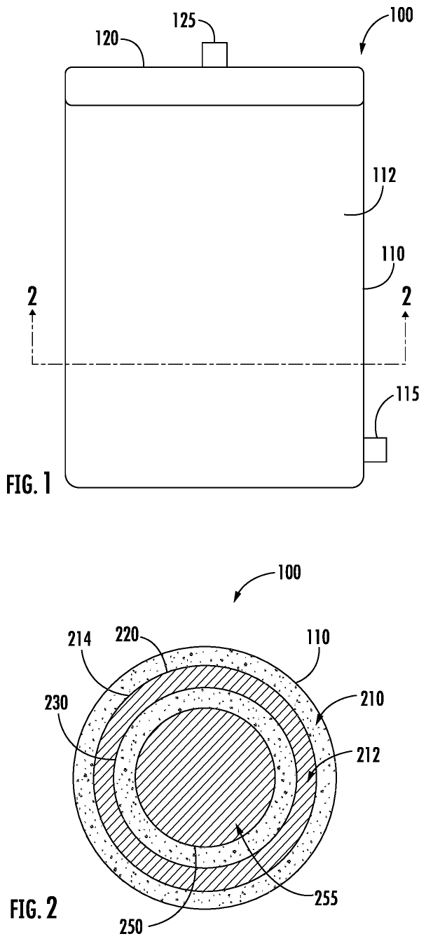

FIG. 1 illustrates a side view of an example cooling system in accordance with various embodiments of the present disclosure. The cooling system 100 comprises a first solution tank 110 with a capping assembly120 in a closed configuration. The capping assembly 120, in the closed configuration, secures to the first solution tank 110. The capping assembly 120 is further configured to enclose a second solution tank (not depicted) while in the closed configuration. The capping assembly120 further comprises a vent assembly 125 that may assist with ventilating air and/or steam from within the second solution tanks. In various embodiments, the vent assembly125 may be disposed on the top surface of the capping assembly 120 (e.g., depicted in FIG. 1). In other embodiments, the vent assembly 125 may be disposed on one or more different surfaces of capping assembly (e.g., left-side, right-side, etc.).

The first solution tank 110 further comprises at least one food edible solution outlet 115. The food edible solution outlet 115 is connected to the second solution tank (not depicted). The food edible solution outlet 115 may be used to dispense a predetermined amount of a food edible solution from within the cooling system 100 to outside the cooling system once the food edible solution has reached a predetermined temperature. The food edible solution outlet 115 may utilize a gravitational force or pressure to help dispense the food edible solution from the second solution tank to outside the cooling system 100 to one or more containers (e.g., bowls, plates, food storage container, etc.). In various embodiments, the food edible solution outlet 115 may further comprise a control knob (e.g., lever, button, and/or the like, not depicted) configured to control the function of the food edible solution outlet 115. The control knob may translate from a closed configuration to an open configuration. The control knob, while in the closed configuration, may prevent the food edible solution from flowing from the second solution tank. The control knob, while in the open configuration, may allow the food edible solution to flow from the inner portion of the second solution tank to the container outside the cooling system.

In various embodiments, the first solution tank 110 comprises at least one sidewall 112. The at least one sidewall 112 may consist of one sidewall which forms a circular or elliptical cross-section in a horizontal plane (e.g., the first solution tank 110 may be shaped as a circle or an ellipse). In various embodiments, the at least one sidewall 112 may consist of multiple sidewalls (e.g., four sidewalls) that form a polygonal cross-section (e.g., square or rectangular) in a horizontal plane (e.g., the first solution tank 110 may be shaped as a polygon. Various other shapes of the first solution tank 110 or the cross-section of the at least one sidewall 112 in a horizontal plane may be used in various other embodiments.

In various embodiments, the at least one sidewall 112 defining the first solution tank 110 may be made out of metal (e.g., stainless steel, aluminum, and/or the like), wherein the metal material has been treated with a food safe coating. In other embodiments, the at least one sidewall 112 defining the first solution tank 110 may comprise various other materials that is configured to perform the same function.

The cooling system 100 comprises a capping assembly120. The capping assembly may be hingedly coupled to the at least one sidewall 112 defining the first solution tank 110. The capping assembly may be moveable between an open configuration (e.g., in which access to the interior of the first solution tank and the second solution tank is enabled, not depicted) and the closed position (e.g., in which access to the interior of the first solution tank and the second solution tank is prevented, depicted in FIG. 1). In various embodiments, the capping assembly120 may be hingedly coupled to the first solution tank 110 by a spring-loaded hinge assembly. In various embodiments, the vent assembly125 is at least partially disposed on the capping assembly120. In various embodiments, a clamping assembly may be used to secure the capping assembly120 in the closed position.

In various embodiments, the vent assembly 125 may be configured to release excess pressure, air, and/or steam from the interior of the first solution tank 110 and/or the interior of the second solution tank. In various embodiments, the vent assembly 125 may be configured such that a user may, through interaction with an external pressure release casing of the vent portion, set a pressure threshold. In various embodiment, the vent assembly 125 may be translate from a closed configuration to an open configuration. While in the closed configuration, the food edible solution may be sealed from the outside environment and/or prevent the food edible solution from flowing within the interior of the second solution tank through the food edible solution outlet 115. While in the open configuration, the food edible solution may be configured to flow from the interior of the second solution tank through the food edible solution outlet 115.

FIG. 2 illustrates a top view of a cooling system 100 with the capping assembly 120 in the open configuration in accordance with various embodiments of the present disclosure. The cooling system 100 further comprise at least one food edible solution tube 220, at least one cooling fluid tube 230, and/or a second solution tank 250. The second solution tank 250 is configured to be position within the first solution tank 110. Further, the second solution tank 250 may have comprise the same general shape as the first solution tank 110 (e.g., if first solution tank is circular the second solution tank is circular). In various embodiments, the second solution tank 250 comprises a volume less than that of the first solution tank 110 and defines a gap 214 in between the outermost surface of the second solution tank and the innermost surface of the first solution tank. The gap 214 may encompass the second solution tank 250 entirely. Further, the gap 214 may receive and/or store a cooling fluid 210. In some embodiments, the cooling fluid 210 may coat the second solution tank 250, while the second solution tank 250 is within the first solution tank 110. In some embodiments, the second solution tank 250 may contact at least partially with the first solution tank 110, such that, the gap encompasses the sidewalls of the second solution tank 250. In other embodiments, the second solution tank 250 is at least partially suspended in the cooling fluid, such that, the gap 214 may be extend beneath the lowermost surface of the second solution tank 250.

With further reference to FIG. 2, in various embodiments, the cooling fluid tube 230 and/or the food edible solution tube 220 may be configured coil around the second solution tank within the gap 214. The cooling fluid tube 230 and/or the food edible solution tube 220 may coil along the length direction of the second solution tank 250. In various embodiments, the cooling fluid tube 230 may coil around the second solution tank 250 in a spiral pattern. The cooling fluid tube 230 may engage with and/or secure to the second solution tank 250. Further, the cooling fluid tube 230 may transport the cooling fluid 210 from an inlet (not depicted) of the cooling fluid tube 230 through an outlet (not depicted) of the cooling fluid tube. In various embodiments, the inlet is configured to receive cooling fluid from the gap 214 and/or the outlet is configured to flow cooling fluid back into the gap. The flowing of the cooling fluid 210 may be configured to decrease the temperature of the food edible solution 212 within the food edible solution tube 220 and/or within an interior 255 of the second solution tank 250. In some embodiments, the cooling fluid tube 230 may comprise a cycle loop, such that, the cooling fluid 210 flows in a continuous loop through the cooling fluid tube.

With even further reference to FIG. 2, in various embodiments, the food edible solution tube 220 may coil around the second solution tank 250 in the same manner of the cooling fluid tube 230. The food edible solution tube 220 may be configured to be disposed within gaps of the spiral configuration of the cooling fluid tube 230. In various embodiments, the food edible solution 212 flows from an inlet (not depict) of the food edible solution tube to a tank inlet (not depicted). The food edible solution 212 flows through the tank inlet at an angle, such that, the food edible solution 212 flows in the interior of the second solution tank 255 forming a vortex configuration. The vortex configuration may mix the food edible solution together. In some embodiments, the food edible solution 212, as flowing through the food edible solution tube 220, may decrease temperature due to the cooling fluid 210.

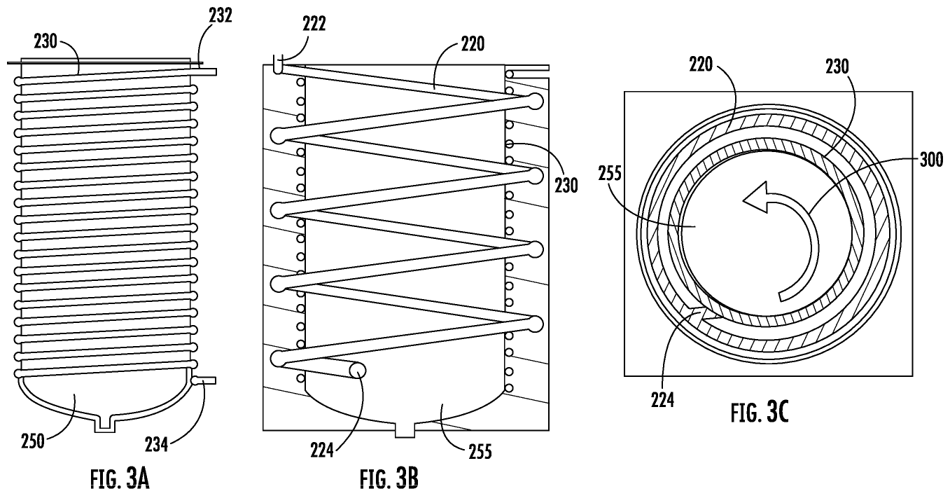

FIGS. 3A-3C illustrate perspective views of an interior of a cooling system in accordance with various embodiments of the present disclosure. Referring to FIG. 3A, in various embodiment, the cooling fluid tube 230 may further comprise at least one cooling fluid inlet 232 and/or at least one cooling fluid outlet 234. The cooling fluid inlet 232 may be disposed vertically above the cooling fluid outlet 234. In some embodiments, the cooling fluid inlet 232 and the cooling fluid outlet 234 are configured to be on the same side of the second solution tank 250. In other embodiments, the cooling fluid inlet 232 and the cooling fluid outlet may be disposed on different sides of the second solution tank. In various embodiments, the cooling fluid inlet 232 may pump at least partially cooling fluid from the between through the cooling fluid tube 230 to the cooling fluid outlet 234, wherein the cooling fluid is configured to return to the gap.

With further reference to FIG. 3A, in various embodiments, the cooling fluid tube 230 may be configured to spiral around the second solution tank 250. The cooling fluid tube 230 may secure at least partially to the second solution tank 250, wherein the cooling fluid tube 230 contacts the second solution tank 250. The cooling fluid tube 230 spirals may comprise a space between each other, wherein the spirals of the cooling fluid tube 230 are spaced by a predetermined amount of space. The spirals are configured to assist in flowing the cooling fluid around the second solution tank 250, wherein the cooling fluid is configured to reduce the temperature of the second solution tank 250. The spirals may utilize the gravitational force to assist with flowing the cooling fluid from the cooling fluid inlet 232 to the cooling fluid outlet 234. In other embodiments, the spiraling pattern of the cooling fluid tube 230 may be configured in a manner in which there is no space between each spiral. In various embodiments, the spirals of the cooling fluid tube 230 may extend along the length of the second solution tank.

Referring now to FIG. 3B, in various embodiments, the food edible solution tube 220 may spiral in a continuous pattern. The cooling fluid tube 230 may spiral in a continuous pattern similar to that of the cooling fluid tube. In various embodiments, the food edible solution tube 220 may spiral in between gaps defined by the cooling fluid tube, wherein the food edible solution tube 220 contacts the second solution tank 250 at least partially. In some embodiments, the spirals of the food edible solution tube 220 may be spaced out further thank the spirals of the cooling fluid tube.

With further reference to FIG. 3B, in various embodiments, the food edible solution tube 220 may comprise at least one food edible solution inlet 222 and/or at least one food edible solution tank inlet 224. The food edible solution inlet 222 may be configured to receive at least one food edible solution by various means. In some embodiments, the food edible solution may be poured into the food edible solution inlet 222 causing the food edible solution to flow from the food edible solution inlet 222 to the food edible solution tank inlet. In other embodiments, the food edible solution inlet 222 may be connected to one or more additional kitchen equipment (e.g., crock pot, pressure cooker, etc.). The additional kitchen equipment may flow the food edible solution to the food edible solution inlet 222, wherein the food edible solution flows through the food edible solution tube 220 and out the food edible solution tank inlet 224. In various embodiments, the food edible solution, while flowing through the food edible solution tube 220, may reduce its temperature due to the cooling fluid surrounding the food edible solution tube 220.

With even further reference to FIG. 3B, in various embodiments, the food edible solution tank inlet 224 may be disposed within the interior of the second solution tank 255. The food edible solution tank inlet 224 allows for the food edible solution to flow from within the food edible solution tube 220 to the interior of the second solution tank 255. In various embodiments, the food edible solution tank inlet 224 may be set at a predetermined angle, such that, the food edible solution flows out of the food edible solution tube 220 at said angle. The angle is configured to cause the food edible solution to create a vortex configuration within the interior of the second solution tank 255. The vortex configuration may be further configured to cause the food edible solution to mix together and/or further decrease the temperature of the food edible solution.

Referring to FIG. 3C, in various embodiment, the food edible solution is configured to flow from the food edible solution tube 220 to the interior of the second solution tank 255 exiting via the food edible solution tank inlet 224. The food edible solution may create a rotational vortex configuration 300 when exiting the food edible solution tank inlet 224. The rotational vortex configuration 300 may comprise a counterclockwise rotation configuration. In other embodiments, the rotational vortex configuration 300 may comprise a clockwise rotational configuration.

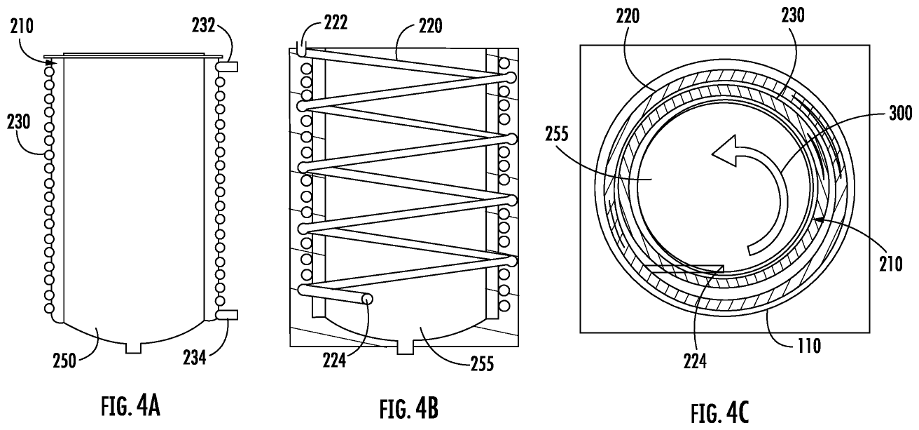

FIGS. 4A-4C illustrate perspective views of an interior of a cooling system in accordance with various embodiments of the present disclosure. Referring to FIG. 4A, in various embodiment, the cooling fluid tube 230 comprise a configuration similar to the one described with reference to FIG. 3A, wherein the cooling fluid tube comprises at least one cooling fluid inlet 232 and/or at least one cooling fluid outlet 234. The cooling fluid inlet 232 may be disposed vertically above the cooling fluid outlet 234. In some embodiments, the cooling fluid inlet 232 and the cooling fluid outlet 234 are configured to be on the same side of the second solution tank 250. In other embodiments, the cooling fluid inlet 232 and the cooling fluid outlet may be disposed on different sides of the second solution tank. In various embodiments, the cooling fluid inlet 232 may pump at least partially cooling fluid from the gap between through the cooling fluid tube 230 to the cooling fluid outlet 234, wherein the cooling fluid is configured to return to the gap.

With further reference to FIG. 4A, in various embodiments, the cooling fluid tube 230 may be configured to spiral around the second solution tank 250. In the depicted embodiment, the cooling fluid tube 230 is configured not to contact the second solution tank 250. A layer of the cooling fluid may be configured to fill the space in between the cooling fluid tube 230 and the second solution tank 250. In various embodiments, the food edible solution tube may be configured to spiral in between the cooling fluid tube 230 and the second solution tank 250, wherein the cooling fluid tube 230 is configured to assist in reducing the temperature of the food edible solution flowing within the food edible solution tube and/or the second solution tank 250. In various embodiments, the spirals are configured to assist in flowing the cooling fluid around the second solution tank 250 and/or the food edible solution tube. In other embodiments, the spiraling pattern of the cooling fluid tube 230 may be configured in a manner in which there is no space between each spiral.

Referring now to FIG. 4B, in various embodiments, the food edible solution tube 220 may spiral in a continuous pattern. The cooling fluid tube 230 may spiral in a continuous pattern similar to that of the cooling fluid tube. In various embodiments, the food edible solution tube 220 may spiral in between gaps defined by the cooling fluid tube, wherein the food edible solution tube 220 contacts the second solution tank 250 at least partially. In other embodiments, the food edible solution tube 220 may disposed between the cooling fluid tube and the second solution tank, wherein the cooling fluid tube contacts a first side of the food edible solution tube 220 and the second solution tank 250 contacts a second side, opposite to the first side, of the food edible solution tank.

With further reference to FIG. 4B, in various embodiments, the food edible solution tube 220 may comprise at least one food edible solution inlet 222 and/or at least one food edible solution tank inlet 224. The food edible solution inlet 222 may be configured to receive at least one food edible solution by various means. In some embodiments, the food edible solution may be poured into the food edible solution inlet 222 causing the food edible solution to flow from the food edible solution inlet 222 to the food edible solution tank inlet. In other embodiments, the food edible solution inlet 222 may be connected to one or more additional kitchen equipment (e.g., crock pot, pressure cooker, etc.). The additional kitchen equipment may flow the food edible solution to the food edible solution inlet 222, wherein the food edible solution flows through the food edible solution tube 220 and out the food edible solution tank inlet 224. In various embodiments, the food edible solution, while flowing through the food edible solution tube 220, may reduce its temperature due to the cooling fluid surrounding the food edible solution tube 220.

With even further reference to FIG. 4B, in various embodiments, the food edible solution tank inlet 224 may be disposed within the interior of the second solution tank 255. The food edible solution tank inlet 224 allows for the food edible solution to flow from within the food edible solution tube 220 to the interior of the second solution tank 255. In various embodiments, the food edible solution tank inlet 224 may be set at a predetermined angle, such that, the food edible solution flows out of the food edible solution tube 220 at said angle. The angle is configured to cause the food edible solution to create a vortex configuration within the interior of the second solution tank 255. The vortex configuration may be further configured to cause the food edible solution to mix together and/or further decrease the temperature of the food edible solution.

Referring to FIG. 4C, in various embodiment, the food edible solution is configured to flow from the food edible solution tube 220 to the interior of the second solution tank 255 exiting via the food edible solution tank inlet 224. The food edible solution may create a rotational vortex configuration 300 when exiting the food edible solution tank inlet 224. The rotational vortex configuration 300 may comprise a counterclockwise rotation configuration. In other embodiments, the rotational vortex configuration 300 may comprise a clockwise rotational configuration. In the depicted embodiments, a layer of the cooling fluid 210 within the gap is configured to be between the cooling fluid tube 230 and the second solution tank 250.

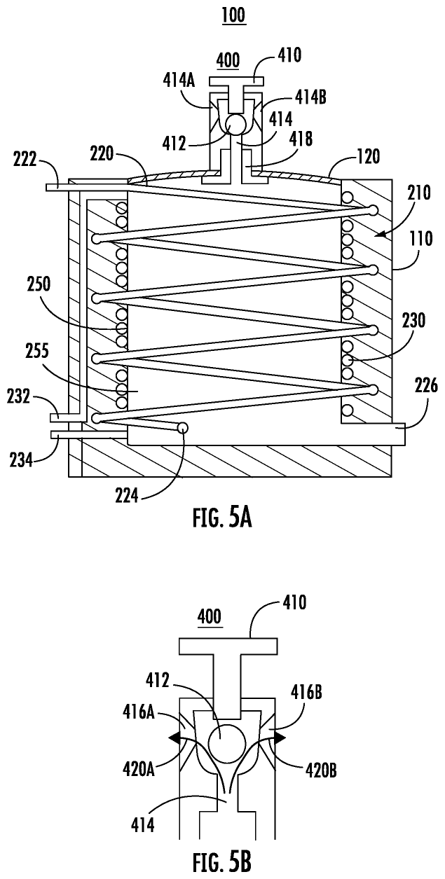

FIGS. 5A-5B illustrate cross-sectional views of a vent assembly 400 in accordance with various embodiments of the present disclosure. The vent assembly is coupled to the capping assembly 120 such that a channel 414 passes through the capping assembly 120. The vent assembly 400 may be connected to the capping assembly via one or more connection elements 418. The vent assembly 400 is configured to allow for air and/or steam to expel from within the interior of the second solution tank. In some embodiments, the vent assembly 400 may be further configured to assist with the flowing of the food edible solution from the interior of the second solution tank through the food edible solution outlet 226. In various embodiments, the vent assembly is configured to move from a closed configuration to an open configuration. The vent assembly may translate from the respective configuration automatically after a predetermined amount of time has passed and/or manually with the assistance of an operator.

With reference to FIG. 5A, in various embodiments, the vent assembly may comprise at least one actuator 410, at least one plunger 412, at least one channel 414, and/or at least one vent portion 416A, 416B (collectively “416”). In various embodiments the actuator 410 is configured to translate from a closed configuration (depicted in FIG. 5A) to an open configuration (depicted in FIG. 5B). The actuator 410, while in the closed configuration, is configured to contact the plunger 412 keeping it in place. The plunger 412 prevents any air and/or steam from escaping the interior of the second solution tank 255 via the channel. Further while in the closed configuration, food edible solution is configured to flow into the interior of the second solution tank 255 via the food edible solution tank inlet 224 at the end of the food edible solution tube 220. In various embodiments, a first vent portion 416A is configured to be disposed on a first side of the vent assembly 400, and a second vent portion 416B is configured to be disposed on a second side of the vent assembly 400. The first vent portion 416A may be disposed linearly opposite to the second vent portion 416B. In various embodiments, the first vent portion 416A and the second vent portion 416B connect to the channel to assist with expelling air and/or steam from within the interior of the second solution tank 255, when in the open configuration.

With reference to FIG. 5B, in various embodiments, the actuator 410 of the vent assembly 400 may translate vertically from the closed configuration to the open configuration (depicted in FIG. 5B). When in the open configuration, the air and/or the steam 420A, 420B (collectively “420”) may expel from the interior of the second solution tank via the channel 414 out the first vent portion 416A and/or the second vent portion 416B. In various embodiments, the air and/or steam 420 are configured to force the plunger 412 upwards thereby clearing the channel 414 and allowing the air and/or steam to exit via the vent portions. While in the open configuration, the food edible solution may be configured to flow from within the interior of the second solution tank 255 out the food edible solution outlet 226.

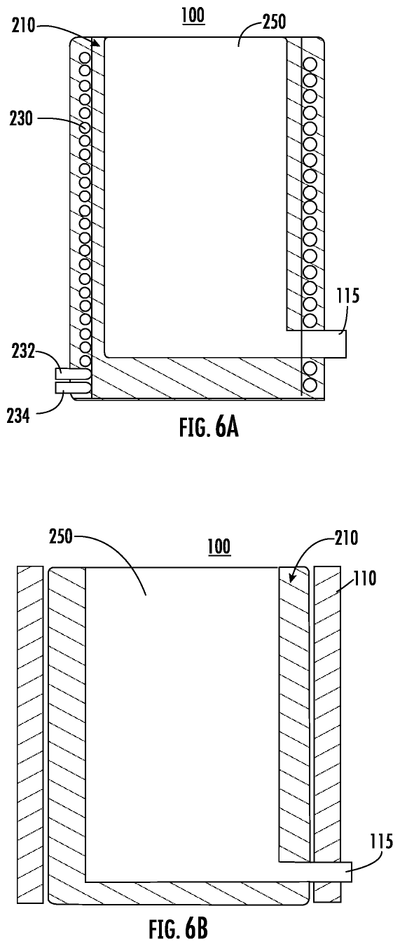

FIGS. 6A and 6B illustrate perspective views of an interior of a cooling system in accordance with various embodiments of the present disclosure. Referring to FIG. 6A, in various embodiments, the cooling fluid tube 230 comprise a configuration similar to the one described with reference to FIG. 3A, wherein the cooling fluid tube comprises at least one cooling fluid inlet 232 and/or at least one cooling fluid outlet 234. The cooling fluid inlet 232 may be disposed vertically above the cooling fluid outlet 234. In some embodiments, the cooling fluid inlet 232 and the cooling fluid outlet 234 are configured to be on the same side of the second solution tank 250. In other embodiments, the cooling fluid inlet 232 and the cooling fluid outlet may be disposed on different sides of the second solution tank. In various embodiments, the cooling fluid inlet 232 may pump at least partially cooling fluid from the gap between through the cooling fluid tube 230 to the cooling fluid outlet 234, wherein the cooling fluid is configured to return to the gap.

With further reference to FIG. 6A, in various embodiments, the cooling fluid tube 230 may be configured to spiral around the second solution tank 250. In the depicted embodiment, the cooling fluid tube 230 is configured not to contact the second solution tank 250. A layer of the cooling fluid may be configured to fill the space in between the cooling fluid tube 230 and the second solution tank 250. In various embodiments, the spirals are configured to assist in flowing the cooling fluid around the second solution tank 250. In other embodiments, the spiraling pattern of the cooling fluid tube 230 may be configured in a manner in which there is no space between each spiral.

Referring now to FIGS. 6B, in various embodiments, the cooling system 100 comprises a first solution tank 110 configured to house a second solution tank 250. In the depicted embodiment, the cooling system 100 may comprise a gap, where the gap is configured to store a cooling fluid 210 therein between. In various embodiments, the cooling system 100 may be configured to act as a low-temperature aging container, wherein the cooling system 100 temperature may be adjusted from −1 to −50 degrees Celsius (e.g., 30.2 to −58 degrees Fahrenheit). In various embodiments, the second solution tank 250 may be configured to store a solution within the second solution tank, where in the solution may be a solid, liquid, and/or a combination thereof. In various embodiments, the cooling system 100 is configured to keep the solution within the second solution tank at a selected tempered (e.g., −1 to −50 degrees Celsius). In some embodiments, the solution within the second solution tank 250 may be further configured to expel from within the second solution tank to the outside environment via an outlet 115.

With further reference to FIG. 6B, in various embodiments, the cooling system 100 may be configured to be used as a medical device. In various embodiments, the cooling system 100 may be configured to store biological matter, pharmaceutical chemicals, vaccinations, and/or the like. In other embodiments, the cooling system may be further configured to store insulin, antibiotics, and some biologic.

Many modifications and other embodiments of the present disclosure set forth herein will come to mind to one skilled in the art to which these embodiments pertain having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions can be provided by alternative embodiments without departing from the scope of the appended claims. In this regard, for example, different combinations of elements and/or functions than those explicitly described above are also contemplated as can be set forth in some of the appended claims. Although specific terms are employed herein, they are used in a generic and descriptive sense only and not for purposes of limitation.

1. A cooling system for cooling a food edible solution, the cooling system comprising:
a first solution tank configured for receiving a cooling fluid therein;
a second solution tank configured for receiving a food edible solution therein, wherein the second solution tank is disposed within the first solution tank;
a cooling fluid tube coiled around the second solution tank, wherein the cooling fluid tube is coiled along a height direction of the second solution tank;
a food edible solution tube coiled around the cooling fluid tube and/or the second solution tank ending with a tank inlet, wherein the food edible solution tube is configured for receiving the food edible solution therein and configured for transporting the food edible solution to an interior portion of the second solution tank via the tank inlet.

2. The cooling system of claim 1, wherein the food edible solution tube further comprises a receiving inlet configured to receive the food edible solution from outside the first solution tank.

3. The cooling system of claim 1, wherein the tank inlet is configured to be at an angle, such that, the food edible solution exits the tank inlet at the same angle of the tank inlet.

4. The cooling system of claim 3, wherein the food edible solution is configured to create a vortex configuration causing the food edible solution to stir within the second solution tank.

5. The cooling system of claim 1, wherein the cooling fluid tube, the food edible solution tube, and/or the second solution tank are submerged at least partially in the cooling fluid.

6. The cooling system of claim 5, wherein the cooling fluid is configured to be contained within a gap defined by a distance between the first solution tank and the second solution tank.

7. The cooling system of claim 1, wherein the cooling system further comprises a compressor configured to pump the cooling fluid through the cooling fluid tube.

8. The cooling system of claim 1, wherein the cooling system further comprises a capping assembly configured to secure to the first solution tank and enclose the first solution tank and the second solution tank.

9. The cooling system of claim 8, wherein the capping assembly further comprises a vent assembly.

10. The cooling system of claim 9, wherein the vent assembly is configured to translate from a closed configuration to an open configuration.

11. The cooling system of claim 10, wherein the vent assembly in the open configuration is configured to let air escape from the second solution tank to an outside environment.

12. The cooling system of claim 11, wherein the vent assembly in the open configuration is further configured to allow the food edible solution to flow through the food edible solution tube from a receiving inlet to the tank inlet.

13. The cooling system of claim 12, wherein the vent assembly is switched to the closed configuration once a predetermined amount of the food edible solution exits the tank inlet to the second solution tank.

14. The cooling system of claim 13, wherein the vent assembly in the closed configuration is configured to seal the first solution tank and/or the second solution tank from the outside environment preventing bacteria from entering the first solution tank and/or the second solution tank.

15. The cooling system of claim 1, wherein a temperature of the food edible solution is configured to decrease while flowing through a receiving inlet to the tank inlet of the food edible solution tube.

16. The cooling system of claim 15, wherein the rate of decreasing temperature of the food edible solution is configured to inhibit microbial and/or bacteria growth in the food edible solution.

17. The cooling system of claim 1, wherein the cooling system further comprises a food edible solution outlet configured to release the food edible solution from the second solution tank.

18. The cooling system of claim 17, wherein the food edible solution is configured to release from the food edible solution outlet due to a gravitational force.

19. The cooling system of claim 1, wherein the cooling fluid tube is configured to be attached to the second solution tank.

20. The cooling system of claim 1, wherein the cooling system further comprises a cooling fluid tube support frame.
